(19) United States
(12) Patent Application Publication
(10) Pub. No.: US 2009/0274056 A1
(43) Pub. Date: Nov. 5, 2009

(54) Method of Identifying at Least One Route Satisfying at Least One Constraint Between a Source Node and a Destination Node in a Telecommunications Network

(75) Inventors: Djamal-Eddine Meddour, Lannion (FR); Riadh Kortebi, Perros-Guirec (FR); Yvon Gourhant, Lannion (FR); Nazim Agoulmine, Paris (FR)

Correspondence Address: COHEN, PONTANI, LIEBERMAN & PAVANE LLP, 551 FIFTH AVENUE, SUITE 1210, NEW YORK, NY, 10176, US

(73) Assignee: France Telecom, Paris (FR)

(21) Appl. No.: 12/295,914

(22) PCT Filed: Mar. 28, 2007
(86) PCT No.: PCT/FR07/51028

§ 371 Date: Oct. 3, 2008

(51) Int. Cl. H04L 12/26

(52) U.S. Cl. 370/248

(57) ABSTRACT

A device (20) for identifying a route satisfying a first constraint between a source node and a destination node in a telecommunications network. The device includes: means (31, 32, 33) for implementing a proactive routing protocol (R_{PR}) adapted to establish a routing table (TR) and a topology table (TT); test means (31, 32, 33) adapted to verify whether a route between the source node S and the destination node D determined from the routing table (TR) satisfies said first constraint; means (31, 32, 33) for selecting a predetermined number (k) of potential routes (Rₖ) from said topology table (TT); and search means (31, 32, 33) adapted to search for a route (R) satisfying said first constraint among said potential routes (Rₖ).

### BACKGROUND OF THE INVENTION

The field of the invention is that of routing in a telecommunications network.

The invention has a particular application to ad hoc telecommunications networks, although this is not limiting on the invention.

Such networks consist of mobile and/or fixed nodes having the property of automatically and dynamically building a network able to route packets from any node of the network to any other node provided that a radio link can be set up between a node and its neighbors.

Packets are transmitted between the source node and the destination node either directly if the destination node is in the connectivity area of the source node or via intermediate neighbor nodes serving as routers if the destination node is out of range of a source.

The nodes are therefore responsible for continuously setting up and maintaining the connectivity of the network.

They do this using ad hoc routing protocols.

Generally speaking, there are two major families of routing protocols, i.e. proactive protocols and reactive protocols.

The invention relates to a hybrid protocol using both techniques.

In a proactive routing protocol, there is a mechanism for periodic exchange of control messages so that the topology of the network can be constructed in a distributed manner by each of its nodes.

This is done by broadcasting control messages to inform all nodes of the evolution of the network topology. Each node periodically updates its routing table on reception of these control messages.

Proactive routing protocols provide very good visibility of the network topology and immediate availability of routes.

In a proactive routing protocol, routes are generally calculated by a shortest path algorithm using a metric defined on the basis of predetermined constraints, for example number of hops, quality of service (QoS), etc.

Consequently, proactive routing protocols are not suitable if these constraints vary, because the precalculated routes are based on hypotheses that are no longer correct.

In contrast to a proactive approach, in a reactive routing protocol, a source node calculates routes to a destination node only at the request of an application seeking to send a packet to the destination node.

The route is calculated by broadcasting a query throughout the network. The response to this broadcast query enables the source node to obtain topological information relating to the route.

Thus in a reactive protocol routes are created on demand. These routing protocols are therefore very suitable for networks in which constraints are liable to vary in time.

In contrast, reactive protocols have the major drawback that they incur a high cost through flooding the network when discovering routes, in contrast to proactive routing protocols, which maintain a view of the network topology.

### OBJECT AND SUMMARY OF THE INVENTION

Generally speaking, the invention is directed to a new method of identifying routes suitable for networks in which constraints taken into account to calculate routes are liable to vary in time.

To be more precise, the invention relates to a method of identifying a route satisfying a first constraint between a source node and a destination node in a telecommunications network in which a routing table and a topology table are established using a proactive protocol (P_{RP}).

The method includes a step of testing a route determined using the routing table established using a proactive routing protocol.

In the event of failure of said test step, the method includes:
a step of selecting a predetermined number of potential routes from the topology table; and
a step of searching for a route satisfying said first constraint among the potential routes.

In a correlated way, the invention relates to a device for identifying a route satisfying a first constraint between a source node and a destination node in a telecommunications network.

This device includes:
means for implementing a proactive routing protocol adapted to establish a routing table and a topology table;
test means adapted to verify whether a route between the source node and the destination node determined from the routing table satisfies said first constraint;
means for selecting a predetermined number of potential routes from said topology table; and
search means adapted to search for a route satisfying said first constraint among said potential routes.

Generally speaking, the invention is therefore aimed at a method and a device for implementing a reactive protocol to search for new routes if routes previously established by a proactive protocol do not find a route that satisfies some given constraint identified between a source node and a destination node.

In other words, so as not to broadcast unnecessary queries, routes are looked for a priori among those identified by the proactive protocol.

However, if the routes identified by the proactive protocol do not satisfy the constraint, a reactive protocol is triggered to identify new routes.

The search for new routes uses a topology table established by the proactive protocol, so that broadcast queries do not flood the network, but follow only a limited number of potential routes, which is highly advantageous.

In one particular implementation of the invention, the potential routes are calculated using a graph search algorithm, for example a BBS or DFS algorithm, as described in “Introduction to Algorithms” by Thomas H. Cormen, Charles E. Leiserson, Ronald L. Rivest, and Clifford Stein, Second Edition, ISBN: 0262032937.

In one particular implementation of the invention, during the search step, a search query is broadcast on the potential routes using a source routing mechanism so that, when it reaches the destination node, the query contains all the references of all the nodes on the route.

In a source routing mechanism, the identities of the nodes are inserted into queries as they progress through the network.

In one particular implementation of the invention, the proactive routing protocol establishes the routing table taking account of a second constraint different from the first-mentioned constraint.

To limit the complexity of the proactive routing protocol, the number of second constraints is preferably limited to three.

In this particular implementation of the invention, the reactive routing protocol is used when searching for a route that must satisfy at least the first constraint.

In one particular implementation of the invention, the second constraints taken into account by the proactive protocol to construct the routing tables are quality of service metrics, for example:
delay;
loss rate; and
available bandwidth.

The invention is especially beneficial if the network nodes are mobile telecommunication devices.

In this implementation, the first constraint, which triggers use of the reactive protocol, can for example be a constraint that is satisfied when the cumulative energy available in the mobile devices constituting a route (in other words the length of time they have left to run) exceeds a predetermined minimum energy level.

In one particular implementation of the invention, the reactive routing protocol identifies a number of possible routes between the source node and the destination node. A selection step then uses a metric taking into account the number of hops between the source node and the destination node to select the best route from the possible routes.

In one particular implementation, the steps of the route identification method are determined by computer program instructions.

In the present document, the term “computer” is to be understood in a broad sense, and refers to any data processing device and in particular to a cellular telephone.

Consequently, the invention is also directed to a computer program on an information medium, which program can be executed in a route identification device or more generally in a computer and includes instructions adapted to execute the steps of the above route identification method.

This program can use any programming language and take the form of source code, object code or an intermediate code between source code and object code, such as a partially compiled form, or any other desirable form.

The invention is also directed to a computer-readable information medium containing instructions of the above computer program.

The information medium can be any entity or device able to store the program. For example, the information medium can include storage means, such as a ROM, for example a CD ROM or a microelectronic circuit ROM, or magnetic storage means, such as a diskette (floppy disk) or a hard disk.

The information medium can be a transmissible medium such as an electrical or optical signal, which can be routed via an electrical or optical cable, by radio or by other means. The program of the invention can in particular be downloaded over an Internet-type network.

Alternatively, the information medium can be an integrated circuit into which the program is incorporated, the circuit being adapted to execute the method in question or to be used in its execution.

The invention is also directed to a telecommunications network including nodes adapted to execute the above route identification method.

### BRIEF DESCRIPTION OF THE DRAWINGS

Other features and advantages of the present invention emerge from the description given with reference to the appendices and to the drawings, which illustrate a non-limiting implementation of the invention, and in which:

Appendix 1 is a listing in pseudo-code of a computer program for implementing the known Dijkstra algorithm;

Appendices 2A and 2B are listings in pseudo-code of a modified Dijkstra algorithm used in one particular implementation of the invention;

FIG. 1 represents an ad hoc network in which the invention can be used;

FIG. 2 represents a routing table of a node of this network;

FIG. 3 is a diagram representing one particular embodiment of a route identification device of the invention; and

FIG. 4 is a flowchart representing the main steps of one particular implementation of a route identification method of the invention.

### DETAILED DESCRIPTION OF ONE IMPLEMENTATION

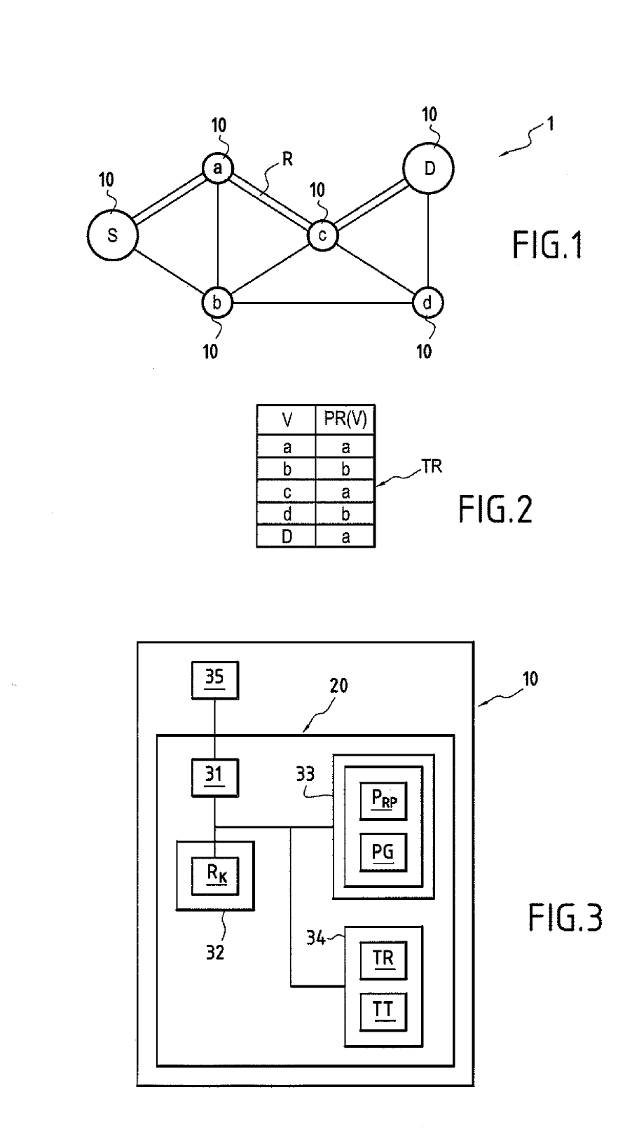

FIG. 1 represents an ad hoc network 1 in which the invention can be used.

This network consists of a set of nodes 10.

These nodes can be identical or not. For example, they can all be mobile devices.

In the remainder of this document:
a source node is denoted S;
a destination node is denoted D; and
intermediate nodes that can be used to route a packet between the source node S and the destination node D are denoted a, b, c, d.

A single line or a double line between two nodes 10 represents the fact that those two nodes are neighbors and that communication by radio can be established between them to route a packet.

The Dijkstra shortest path algorithm is described below with reference to Appendix 1, and can be used by a proactive routing protocol to establish a routing table TR for the ad hoc network 1 from a topology table TT.

In this known algorithm:
a topology table TT is a matrix that represents the nodes of the network and the links between them; it can be constructed by periodic exchange of messages between the nodes, as in the OLSR (Optimized Link State Routing) proactive protocol; and
a routing table TR at a node S contains, for each destination node D in the network, the address of an element E that is the next routing node toward the destination node D and is one hop away from the node S.

According to predefined metrics, for example the number of hops, the Dijkstra algorithm finds the shortest path between a given source node s and any node v of the graph G representing the ad hoc network 1.

The Dijkstra algorithm uses the relaxation technique.

To be more precise, for each node v there is an attribute d[v] that is an upper bound for a shortest path between the source s and v.

This attribute d[v] is called the “shortest path estimate”.

The estimates and predecessors (π[.]) are initialized by the “Initialisation” procedure in Appendix 1.

The “Relax” procedure is used for the relaxation process.

FIG. 2 shows the routing table TR obtained using the Dijkstra algorithm.

Using the notation of Appendix 1, the set E contains a list of the nodes forming the shortest path (in terms of a chosen routing metric) between the source s and the destination d. The element of E that is one hop away from s is the “next router” toward the destination node d in the routing table TR.

The routing table TR shown in FIG. 2 is that of the source S.

It includes a first column including all the nodes a, b, c, d, D of the ad hoc network 1 and a second column including, against a node v, the next router PR(V) after S in the shortest path to v.

In FIG. 1, the shortest path R between the source node S and the destination node D is represented in double line.

Accordingly, to reach D from S, the shortest path passes first through the intermediate node a, which is why the intermediate node a is associated with the destination node D in the routing table TR.

The Dijkstra algorithm described previously with reference to Appendix 1 uses a metric representing the number of hops between the source node S and the destination node D.

A modified Dijkstra algorithm is described below with reference to appendices 2A and 2B, this algorithm using, instead of the “number of hops” metric, a metric that consists of three primary quality of service metrics:
the delay (constraint C₁);
the loss rate (constraint C₂); and
the available bandwidth in the ad hoc network 1 (constraint C₃).

The loss rate metric is multiplicative and can be transformed into an additive metric as described below:
If pᵢⱼ is the probability of loss on the link (i, j), the probability of success on the link (i, j) is qᵢⱼ=1−pᵢⱼ. Thus on the path P from the source i to the destination t the probability of loss is:

Pₗₒₛₛ(P)=1−((qᵢⱼ)(qⱼₖ), . . . , (qᵢₜ))

Assuming that the logarithmic probability plsᵢⱼ of success of the link (i, j) is defined by plsᵢⱼ=−log q_{if}, then the logarithmic probability of success on the path P is:

$$pls ( P ) = - {\sum }_{( i , j ) ∈ P} log {q}_{ij}$$

Assuming that the probability of loss on a given route R is less than 0.9, then 0.1<pls(R)<1.

Assume also that the delay assumes integer values. If the millisecond unit gives real values, then the microsecond unit is used to calculate the delays.

A method of searching for the shortest path satisfying the three QoS metrics, if such a path exists, is described below.

G=(N, A) is the graph representing the ad hoc network 1, including N nodes and A arcs (links). Each arc is assigned two real values:
bᵢⱼ the available bandwidth and the composite metric; and
mᵢⱼ=plsᵢⱼ+dᵢⱼ, where dᵢⱼ represents the delay on the link (i, j). The following four constants are defined:
B: the minimum bandwidth;
D: the maximum delay;
P: the maximum logarithmic probability of success (pls);
M=D+P: the maximum value of the composite metric.

Consider a route R=(s, k, i, . . . , r, d). The available bandwidth on R is min[bₛₖ, bₖᵢ, . . . , b_{rd}] and the length of R is mₛₖ+mₖᵢ+ . . . , +m_{rd}.

The problem is to find a route R such that the available bandwidth on R is greater than B and the length of R is less than M.

If R is a route from the vertex s to the vertex d including y hops, and if plsᵢⱼ<P/y for each link (i, j) belonging to the route R, then pls(R)<P. However, the value of y is unknown during the search for a route. The idea is therefore to restrict plsᵢⱼ to P/C, where C is the length (in terms of the number of hops) of the shortest route between s and d (that is an optimistic hypothesis).

Two counters are maintained:
NSᵢ: the difference between C and the length (in terms of the number of hops) of the path traveled from the source to the node i;
RPᵢ: the difference between P and the current value of the logarithmic probability of success from the source to the node i.

Thus the maximum logarithmic probability of success that can be added on each step is RPᵢ/NCᵢ instead of P/C.

The modified Dijkstra algorithm of Appendices 2A and 2B solves the problem stated above by assuming that the vertex s is the source node and that vertex d is the destination node.

This appendix uses the following variables and notation:
bᵢⱼ: the available bandwidth on the link (i, j);
mᵢⱼ: the cost of the link (i, j) (mᵢⱼ=plsᵢⱼ+dᵢⱼ, where: dᵢⱼ is the delay on the link (i, j) and plsᵢⱼ is the logarithmic probability of success on the link (i, j));
π[i]: the predecessor of node i;
└x┘: the integer part of x;
Mᵢ: the length of the route under construction.

An identification device 20 of the invention is described below with reference to FIG. 3.

In the example described here, the device 20 is incorporated into a mobile telephone 10 constituting a node of the ad hoc network 1.

In the example described here, the identification device 20 of the invention includes conventional processing means, i.e. a processor 31, a read-only memory (ROM) 33, and a random-access memory (RAM) 312.

In the example described here, a computer program PG of the invention is stored in the read-only memory 33.

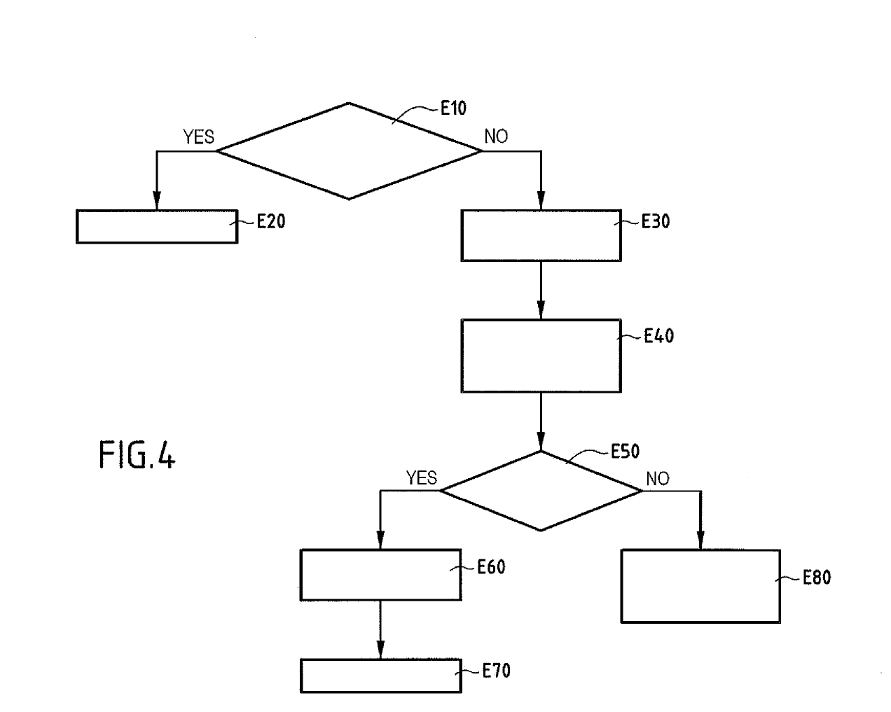

This program includes instructions for executing the steps of the route identification method of the invention, of which FIG. 4 is a flowchart.

In the implementation described here, the computer program PG includes a module P_{RP} adapted to implement the proactive routing protocol P_{RP} based on the modified Dijkstra algorithm described above with reference to Appendices 2A and 2B.

In particular, the proactive routing module P_{RP} establishes and maintains a routing table TR and a topology table TT which, in the example described here, are stored in a non-volatile rewritable memory 34 of the identification device 20 of the invention.

Using the notation of Appendix 1B, the set L contains a list of the nodes forming the shortest path between the source s and the destination d. The element of L to reach the destination node d that is one hop away from the source s is the “next router” in the routing table TR.

The main steps of one particular implementation of the identification method of the invention are described below with reference to FIG. 4.

In this context the routing table TR and the topology table TT have already been established by the proactive routing module P_{RP}.

Accordingly, the topology table TT represents a topology of the ad hoc network taking into account the three constraints consisting of the delay metric (C₁), the loss rate metric (C₂), and the available bandwidth metric (C₃).

It is assumed in this example that a new connection that requires a fourth constraint C₄ to be satisfied is to be set up between the source node S and the destination node D.

In the example described here, this constraint C₄ is satisfied if the cumulative available energy eᵢ of the mobile devices 10 constituting the route R between the source node S and the destination node D is greater than a predetermined minimum energy level E.

During a first test step E10 of the method, whether the route between the source node S and the destination node D corresponding to the shortest path defined by the routing table TR satisfies this fourth constraint is verified.

The source node S sends a query on the route defined in the routing table TR, for example in source-routing mode. According to the known source-routing mechanisms, as this query crosses the intermediate nodes toward the destination node D, whether this route satisfies the fourth constraint C₄ is verified.

When the destination node is reached, whether the fourth constraint is satisfied is verified.

In the example described here, this amounts to verifying if the sum of the energies available in the mobile telephones S, a, c, and D is greater than the minimum energy E.

If so, a positive response is sent to the source node S and the result of the test E10 is positive. That test is then followed by a step E20 during which a connection is set up between the source node S and the destination node D along the route R defined by the routing table TR.

If not, a negative response is sent to the source node S and the result of the test E10 is negative. A reactive routing algorithm is then triggered to identify new routes that can satisfy all the constraints.

To this end, during a step E30, the node S determines a certain number of potential routes Rₖ from the topology table TT kept up-to-date by the proactive routing module P_{RP} using a graph search algorithm.

The graph search algorithms used can be of the BFS (Breadth First Search) or DFS (Depth First Search) type, as described in “Introduction to Algorithms” by Thomas H. Cormen, Charles E. Leiserson, Ronald L. Rivest, and Clifford Stein, Second Edition, ISBN: 0262032937.

In the example described here, these potential routes Rₖ are stored in the random-access memory 32 of the identification device of the invention.

This step E30 of selecting potential routes Rₖ is followed by a step E40 during which the source node S sends a query on each of the routes Rₖ, for example in source-routing mode.

According to the known source-routing mechanisms, whether this route satisfies the fourth constraint C₄ is verified as this query crosses the intermediate nodes toward the destination node D.

Because this is an additive constraint, it is typical to establish the cumulative sum of the energies eᵢ available in all the nodes that the query crosses.

When the destination node D is reached, whether the energy of this path is greater than the required minimum value E is verified.

If so, a positive response is sent to the source node S.

If not, a negative response is sent to the source node S.

This step E40 of broadcasting the query is followed by a step E50 during which the source node S verifies whether any potential routes satisfy the fourth constraint as a function of the responses) received in the preceding step.

If so, the result of the test E50 is positive. That test is then followed by a step E60 during which the satisfactory route comprising the fewest hops is chosen.

Then, during a step E70, the connection between the source node S and the destination node D is established along that route.

If none of the potential routes Rₖ satisfies the fourth constraint, the result of the test E50 is negative.

That test is then followed by a step E80 during which a query is broadcast over the entire ad hoc network 1 to search for routes that satisfy the constraint C₄.

In the example described above, the reactive routing algorithm is used to search for a route if a new constraint has to be taken into account (here the fourth constraint).

In other embodiments of the invention, reactive routing can be used at the initiative of the routing application if the proactive routing algorithm does not constitute or no longer constitutes a satisfactory solution for identifying routes, even if the constraints taken into account for calculating routes are unchanged.

```
APPENDIX 1
Initialisation (G, s)
    START
    for each node v
          do d[v] := ∞
                Π[v] := NIL
    d[s] := 0
    END
Relax (u, v)
    START
    if d[v] > d[u] + w(u, v)
        then d[v] := d[u] + w(u, v)
              Π[v] := u
    END
Dijkstra (G, w, s)
    START
    Initialisation (G, s)
    E := Ø
    F := S[G]
    while F≠ Ø
          do u:= Extract−Min(F)
                  E := E U {u}
                  for each vertex v adjacent to u
                        do Relax(u, v)
END
```

```
APPENDIX 2A
Modified_Initialisation (N, A)
START
Dijkstra (N, A) ;
for each vertex i adjacent to j do
    if (bᵢⱼ < B) then
        mᵢⱼ = ∞;
    endif
done
L = {(s, s)} ; NCₛ = C ; RPₛ = P.
for each vertex i , i≠ s do
    Mᵢ = mₛᵢ ; Π[i] = s;
    if (Mᵢ == ∞) then
        NCᵢ = C;
        RPᵢ = P;
    else
        NCᵢ = C − 1;
        RPᵢ = P − (mₛᵢ − └mₛᵢ┘);
    endif
END
Modified_Relax (N,L)
START
for each i ∉L do
    if ((Mₖ + mₖⱼ < Mᵢ) AND (mₖᵢ − └mₖᵢ┘ < RPᵢ/NCᵢ)) then
        Mᵢ = Mₖ + mₖᵢ ;
        Π[i] = k ;
        NCᵢ = NCₖ − 1;
        RPᵢ = RPₖ − └mₖᵢ┘
        endif
    done
END
```

ANNEX 2B

```
Modified_Dijkstra(N,A)
START
Modified_Initialisation (N, A)
F:=S[G]; /* F contains all vertices of the graph G */
while F≠ Ø
    Find k ∉L such that (Mₖ = min_{i∉L}Mᵢ AND Mᵢ − └Mᵢ┘≦P)
        if Mₖ > M then there is no feasible path. STOP.
    L := L∪{(k, Π[k])};
    F :=F−{k} ;
    If destination d is in L route has been found. STOP
    Modified_Relax (N, L);
end while
END
```

1. A method of identifying a route (R) satisfying a first constraint (C₄) between a source node (S) and a destination node (D) in a telecommunications network, in which method a routing table (TR) and a topology table (TT) are established using a proactive protocol (P_{RP}) and a route between the source node S and the destination node D is determined from the routing table (TR), wherein the method comprises:
a test step (E10) of determining whether the route determined from the routing table (TR) satisfies said first constraint and in the event of failure (E20) of said test step (E10):
a step (E30) of selecting a predetermined number (k) of potential routes (Rₖ) from the topology table (TT); and
a step (E40) of searching for a route satisfying said first constraint among said potential routes (Rₖ).

2. The identification method according to claim 1, wherein said potential routes (Rₖ) are selected from the topology table (TT) using a graph search algorithm.

3. The identification method according to claim 1, wherein during said search step (E40), a search query is broadcast on said potential routes (Rₖ) using a “source routing” type mechanism, so that, when it reaches the destination node, the query contains all the references of the nodes of the route.

4. The identification method according to claim 1, wherein said proactive routing protocol (P_{RP}) establishes said routing table (TR) taking into account a second constraint (C₁, C₂, C₃) different from said first constraint (C₄).

5. The identification method according to claim 4, wherein said second constraint (C₁, C₂, C₃) is a quality of service metric.

6. The identification method according to claim 5, wherein three second constraints are used, consisting of the following metrics:
delay (C₁);
loss rate (C₂); and
available bandwidth (C₃).

7. The identification method according to claim 1, wherein the nodes of the network consist of mobile telecommunication devices (10), and wherein said first constraint (C₄) is satisfied if the cumulative available energies (eᵢ) of the nodes constituting a route (R) is greater than a predetermined minimum energy level (E).

8. The identification method according to claim 1, comprising a step (E60) of selecting a single route (R) found during the search step (E40), said selection step (E60) using a metric taking into account the number of hops between said source node (S) and said destination node (D).

9. A route-identifier device (20) for identifying a route (R) satisfying a first constraint (C₄) between a source node (S) and a destination node (D) in a telecommunications network, comprising:
means (31, 32, 33) for implementing a proactive routing protocol (R_{PR}) adapted to establish a routing table (TR) and a topology table (TT);
test means (31, 32, 33) adapted to verify whether a route between the source node S and the destination node D determined from the routing table (TR) satisfies said first constraint;
means (31, 32, 33) for selecting a predetermined number (k) of potential routes (Rₖ) from said topology table (TT); and
search means (31, 32, 33) adapted to search for a route (R) satisfying said first constraint among said potential routes (Rₖ).

10. A computer program (PG) including instructions for executing steps of the route identification method according to claim 1, when said program is executed by a computer (10).

11. A storage medium (33) readable by a computer (10) in which is stored a computer program (PG) including instructions for executing the steps of the route identification method according to claim 1.

12. A telecommunications network (1) including a plurality of nodes (10) adapted to implement the route identification method according to claim 1.

13. Equipment forming a node of a telecommunications network, wherein the equipment comprises the route identifier device according to claim 9.
